(19) United States
(12) Patent Application Publication
(10) Pub. No.: US 2007/0288310 A1
(43) Pub. Date: Dec. 13, 2007

(54) Methods and systems for providing advertising to consumers

(76) Inventors: Frederick B. Boos, Bend, OR (US); Anthony J. Westerberg, Eugene, OR (US)

Correspondence Address: Thomas M. Spear Jr.;c/o Sheasby & Associates, Post Office Box 1274, Bend, OR, 97709-1274, US

(21) Appl. No.: 11/698,289

(22) Filed: Jan. 24, 2007

Related U.S. Application Data
(60) Provisional application No. 60/761,496, filed on Jan. 24, 2006.

(51) Int. Cl. G06Q 30/00

(52) U.S. Cl. 705/14

(57) ABSTRACT

The following disclosure relates generally to methods and systems that have the ability to deliver information to users wherein the timing and content of the information delivered is based upon the location and acts of the user and wherein participating parties may benefit if the user acts upon the information delivered and, more particularly, to advertising methods and systems wherein a merchant's advertisement is delivered to a user's mobile computer based on the user's commercial act at a neighboring merchant and if the user acts upon the advertisement the merchant pays the neighboring merchant a bounty.

### CROSS-REFERENCE TO RELATED APPLICATION

This application claims priority from U.S. Provisional Application No. 60/761,496 filed Jan. 24, 2006 entitled “Methods and Systems for Providing Advertising to Consumers”. The benefits of the filing date of this application are hereby claimed, and the disclosure of said provisional application is hereby incorporated herein by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX:

Not Applicable.

### BACKGROUND OF THE INVENTIONS

Computers have been networked to exchange data between them for decades. One important network, the Internet, comprises a vast number of computers and computer networks interconnected through communication channels. The Internet is used for a variety of reasons, including electronic commerce, exchanging information such as electronic mail, retrieving information and doing research, and the like. Many standards have been established for exchanging information over the Internet, such as electronic mail, Gopher, and the World Wide Web (“WWW”). The WWW service allows a server computer system (i.e. web server or web site) to send graphical web pages of information to a remote client computer system. The remote client computer system (device) can then display the web pages. Each resource (e.g., computer or web page) of the WWW is uniquely identifiable by a Uniform Resource Locator (“URL”). To view a specific web page, a client computer system, or device, specifies the URL for that web page in a request (e.g., a HyperText Transfer Protocol (“HTTP”) request). The request is forwarded to the web server that supports the web page. When that web server receives the request, it sends the requested web page to the client computer system. When the client computer system receives that web page, it typically displays the web page using a browser. A browser is typically a special-purpose application program for requesting and displaying web pages.

Currently, web pages are often defined using HyperText Markup Language (“HTML”). HTML provides a standard set of tags that define how a web page is to be displayed. When a user makes a request to the browser to display a web page, the browser sends the request to the server computer system to transfer to the client computer system an HTML document that defines the web page. When the requested HTML document is received by the client computer system the browser displays the web page as defined by the HTML document. The HTML document contains various tags that control the display of text, graphics, controls, and other features. The HTML document may contain URLs of other web pages available on that server computer server or on other server computer systems.

New protocols, or computer languages, exist, such as Extensible Mark-up Language (“XLM”) and Wireless Access Protocol (“WAP”). XML provides greater flexibility over HTML. WAP provides, among other things, the ability to view web pages over hand-held wireless devices, such as cell phones and portable computers (e.g., PDA's). All of these protocols and devices provide easier ways to provide information to people via various data processing devices. Many other protocols and means for exchanging data between data processing devices continue to develop to further aid the exchange of information.

### BRIEF DESCRIPTION OF THE SEVERAL DRAWINGS

FIG. 1 is a block diagram of a basic and suitable computer that may employ aspects of the invention.

FIG. 2A is a block diagram illustrating a simple, yet suitable system in which aspects of the invention may operate in a networked computer environment.

FIG. 2B is a block diagram illustrating an alternative system to that of FIG. 2A.

FIG. 3 is a block diagram of an advertising system configured in accordance with an embodiment of the invention.

Note: headings provided herein are for convenience and do not necessarily affect the scope or interpretation of the invention.

### DETAILED DESCRIPTION

Various embodiments of the invention will now be described. The following descriptions provide specific details for a thorough understanding and enabling description of these embodiments. It should be noted, however, that the above “Background” describes technologies that may enable aspects and embodiments of the invention. One skilled in the relevant arts will understand, however, that the invention may be practiced without many of these details. Additionally, some well-known structures or functions may not be shown or described in detail, so as to avoid unnecessarily obscuring the relevant description of the various aspects and embodiments of the invention.

The terminology used in the description presented below is intended to be interpreted in its broadest reasonable manner, even though it is being used in conjunction with a detailed description of certain specific embodiments of the invention. Certain terms may even be emphasized herein; however, any terminology intended to be interpreted in any restricted manner will be overly and specifically defined as such in this Detailed Description section.

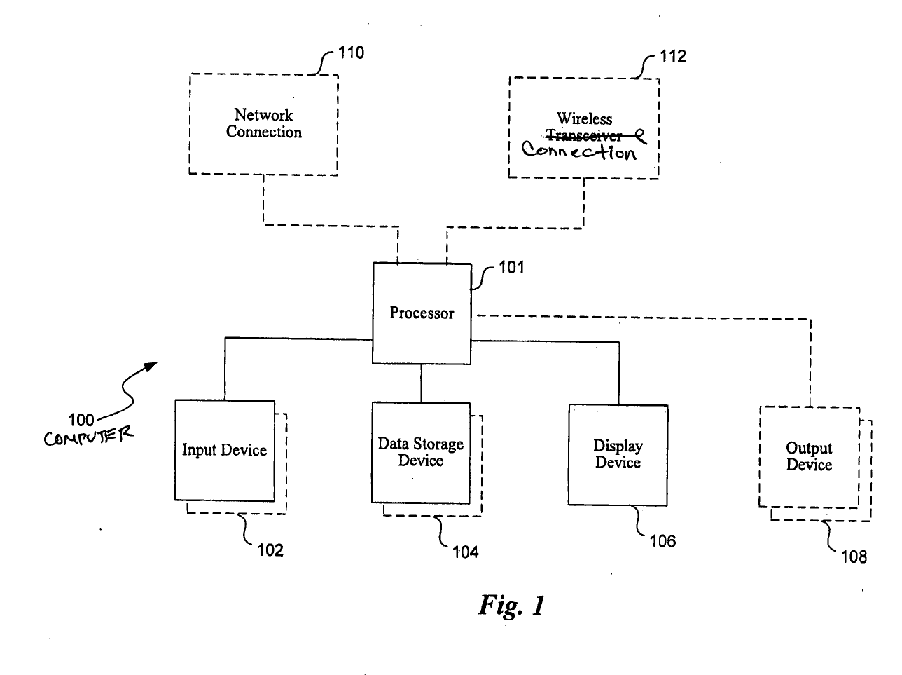

FIG. 1 and the following discussion provide a brief, general description of a suitable computing environment in which aspects of the invention may be implemented. Although not required, aspects and embodiments of the invention will be described in the general context of computer-executable instructions, such as routines executed by a general-purpose computer, e.g., a server or personal computer. Those skilled in the relevant art will appreciate that aspects of the invention may be practiced with other computer system configurations, including Internet appliances, hand-held devices, wearable computers, cellular or mobile phones, multi-purpose systems, microprocessor-based or programmable consumer electronics, set-top boxes, network PCs, mini-computers, mainframe computers and the like—collectively referred to as “device” herein. Aspects of the invention may be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor or device that may perform accordingly. In fact, devices, protocols, languages, devices, processors may change or may be replaced with functional equivalents without digressing from the conceptual scope of the subject invention.

The invention may also be practiced in distributed computing environments, where tasks or modules are performed, in whole or in part, by remote processing devices, which are linked through a communication network, such as a Local Area Network (“LAN”), Wide Area Network (“WAN”), personal area network (PAN), or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g. EEPROM chips), as well as distributed electronically over the Internet or over other networks (including wireless networks). Those skilled in the relevant art will recognize that portions of the invention may reside on a server computer, while corresponding portions reside on a user's computer. Data structures and transmissions of data, which may be data packets, particular to aspects of the invention are also encompassed within the scope of the invention.

Referring to FIG. 1, one embodiment of the invention employs a computer 100, such as a personal computer, PDA, or similar, or functional equivalents thereto, having one or more processors 101 coupled to one or more user input devices 102 and data storage devices 104. The computer is also coupled to at least one output device such as a display device 106 and one or more optional additional output devices 108 (e.g. printer, plotter, speakers, tactile, olfactory output devices, or any means of sensory communication). The computer is preferably coupled to external computers, such as via a network connection 110, or preferably a wireless connection 112, or both.

The input devices 102 may include a keyboard and/or a pointing device such as a mouse. Other input devices are possible such as a microphone, joystick, pen, game pad, scanner, digital camera, video camera, eye-tracking device, and the like. Indeed, any mode for inputting information may be employed. The data storage devices 104 may include any type of computer readable media that can store data accessible by the computer 100, such as magnetic hard and floppy disk drives, optical disk drives, magnetic cassette, tape drives, flash memory cards, digital video disks (DVDs), Bernoulli cartridges, RAMs, ROMs, smart cards, etc. Indeed, any medium for storing or transmitting computer-readable instructions and date may be employed, including a connection port to or node on a network such as a LAN or WAN or the Internet (not shown in FIG. 1).

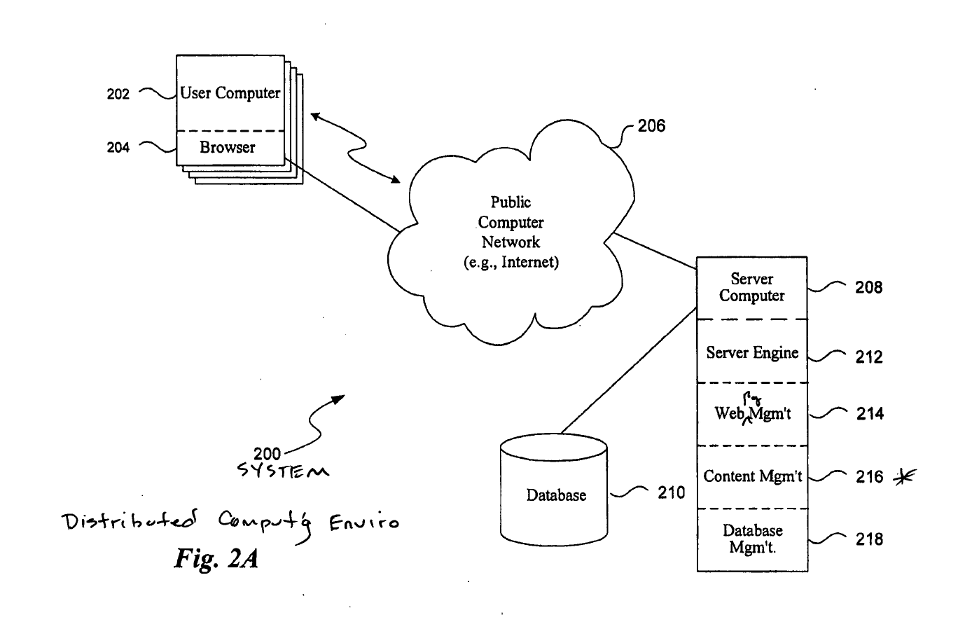

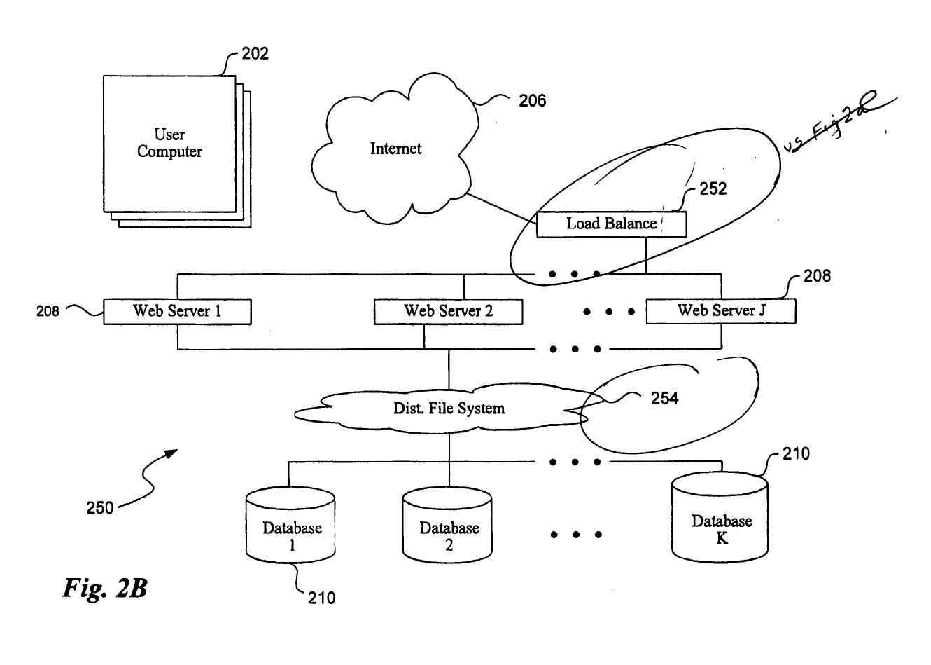

Aspects of the invention may be practiced in a variety of other computing environments. For example, referring to FIG. 2A, a distribution computing environment with a Web (World Wide Web) interface includes at least one user computer 202 in a system 200 as shown, each of which includes a browser program module 204 that permits the computer 202 to access and exchange public or community data, e.g. from the Internet 206, including Web sites within the World Wide Web portion of the Internet. The user's computer 202 may be substantially similar to the computer described above with respect to FIG. 1. A user computer may include other program modules such as an operating system, one or more application programs (e.g., word processing or spread sheet applications or other application programs known in the relevant art), and the like. The computer 202, or computers, may be general-purpose devices that can be programmed to run various types of applications, or they may be single-purpose devices optimized or limited to a particular function or class of functions. Accordingly, portions of the invention may be physically part of the computer 202 or may be performed remotely and communicated to the computer 202. More importantly, while shown with Web browsers, any application program for providing an interface to the user may be employed, such as a graphical user interface, as described in detail below; the use of a Web browser and Web interface are only used as a familiar example here.

A computing environment embodying an aspect of the invention depicted in FIG. 2A may include at least one server computer 208, coupled to a public network 206, performs much or all of the functions for receiving, routing and storing of electronic messages, whether the messages are advertisements or other information, (whether a simple stream of bytes, bits or characters or in a data packet which includes formatted blocks of information which may render network transmissions more efficient and reliable), such as Web pages, audio signals, and electronic images. While a “Public Computer Network” is shown, a private network, such as an intranet may indeed be preferred in some applications (not shown). As can be appreciated by those skilled in the relevant art, the network may have a client-server architecture, in which a computer is dedicated to serving other client computers, or it may have other architectures such as peer-to-peer, in which one or more computers serve simultaneously as the servers and clients. A database 210 or databases, coupled to the server computer(s), may store much of the Web pages and content exchanged between the user computers. The server computer(s), including the database(s), may employ security measures to inhibit malicious attacks on the system and to preserve message integrity and data stored therein (e.g., firewall systems, secure socket layers (SSL), password protection schemes, encryption, and the like).

The server computer 208 may include a server engine 212, a Web page management component 214, a content management component 216 and a database management component 218. The server engine performs basic processing and operating system level tasks. The Web page management component handles creation and display or routing of Web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

Referring to FIG. 2b, an alternative distributed computing environment to that shown in FIG. 1A is shown as a system 250. The system 250 is substantially similar to the system 200, but includes more than one server computer (shown as Web Server 1, 2 . . . J). A load balancing system 252 balances load on the several server computers. Load balancing is a technique well-known in the relevant art for distributing the processing load among two or more computers, to thereby more efficiently process instructions and route date. Such a load balancer can distribute message traffic, particularly during peak traffic times.

A distributed file system 254 couples the Web servers to several databases (shown as Databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

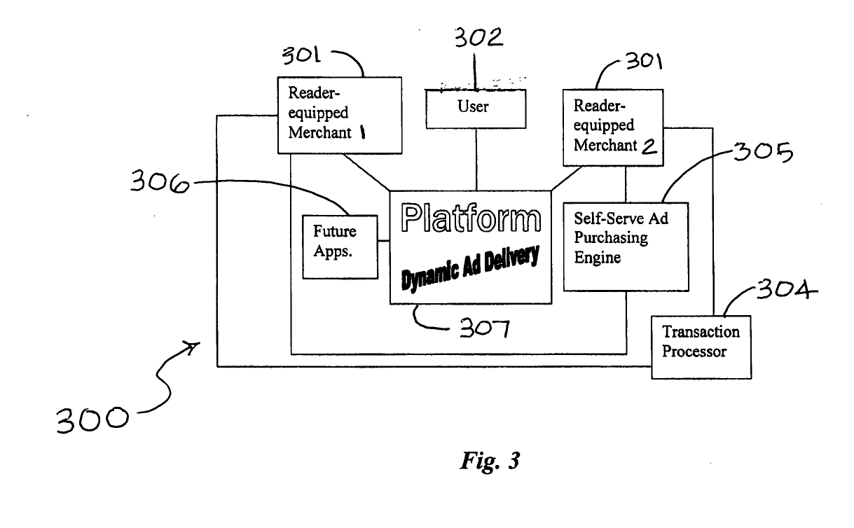

FIG. 3 illustrates an advertising system 300 configured in accordance with an embodiment of the invention. System 300 may include participating merchants who are reader equipped 301 (1, 2 . . . ), a user 302, a transaction processor 304, a self-serve ad purchasing engine 305, optional future applications 306, and the platform, in this case the dynamic ad delivery 307. In one aspect of this embodiment, the system and method are based on a user 302 who is detected by merchant 1's reader and accordingly is determined to be at the location of merchant 1. Merchant 2, who has purchased an advertisement from the self-serve ad purchasing engine 305 wherein based upon certain acts by any participating user a relevant merchant 2 advertisement will be delivered to the user's mobile device, which may be a cell phone, when the user is located at merchant 1's place of business, or other participating merchant in the area of merchant 2. If the user acts upon the advertisement, as evidenced by detection by merchant 2's reader, then merchant 2 will pay a bounty, or alternatively pay or give any benefit in any form to merchant 1. User, merchant 1 and merchant 2 are participating parties in the system. Alternatively, the transaction processor 304 may enable the platform 307 to be by-passed regarding transfers of information or benefits between, in this aspect of this embodiment, any two merchants, or generally between any participating parties.

Merchant readers may be peripheral to, or integral to, for example, a point of sale (POS), point of information (POI), or strategic reader (SR). Accordingly, the “merchants” as described herein, may not be conducting “merchant” business as typically defined. Any means of locating a user may be employed, including GPS and biometrics (such as retinal scans). “Big brother” issues aside, any means of identifying the user and her location may as well be employed, including carriers of any mobile device, credit card, magnetic strip, smart card, contactless NFC readers, flesh embedded RFID chip, biometric or similar. Whatever the device, it merely needs to recognize the presence of the user. A user's presence is detected for example at a POS by purchasing an item.

It follows that readers that detect a user may be anywhere as well, including stores, malls, information centers, stadiums, performing art venues, museums, transportation hubs, public transportation carriers, etc. As long as the device that detects the location of the user is able to, directly or indirectly, associate the location with a first participating party, communicate an ad from a second participating party to the user based upon the user's location, and if it can be determined that the user acted upon the ad, a bounty is paid by the second participating party to the first participating party.

Alternatively, it may be that detection of the user may not be conventional “geographic” location—location may be virtual wherein the location of the user is on a network. Nonetheless, the user can be identified and the activity of the user may be identified. The activity may be associated with a first participating party. For example, a user may be searching the Web for information on ski vacations on his mobile device. As a participating party, the user has allowed the platform 307 to provide him with sales information on sports equipment. The system identifies a first participating party, or entity, based upon this activity (searching for ski vacation opportunities)—for example, a ski equipment retailer. An ad, for example, describing an on-line sale of the first participating party's goods (ski equipment) is sent to the user. If, within a predetermined, or calculated, period of time the user goes to the first participating party's web site or retail store, with or without a purchase, the first participating party pays a benefit to the service provider.

In another example of an aspect of the brick and motor embodiment of the subject invention, the means of monitoring to detect the participating user, may be a particular taps at a POS, POI or SR reader, the platform 307 may create an advertisement stating that a particular set of goods or services relevant to the participating user's location and/or activity, is on sale at the relevant nearby participating store. The advertisement, or other data (in packet form or not) preferably are in the form of an electronic message. The determination of what message to send may be based on a self-selected profile filter associated with each user. The profile may specify the user's interests, types of advertisements s/he desires to receive, times of day that the user does/does not want to receive advertisements, and like information. The profile may change based upon user's activities, if she opts “in” to allow her activities to be tracked and processed—forms of AI well known to those in the relevant art may be utilized to change a profile to the user's benefit.

It should be appreciated that POS, POI, or SR, or other readers may communicate with the system wirelessly. As is well known in the relevant art there are a wide range of technologies and industrial specifications and standards that provide ways for devices to connect and exchange information. Additionally, as is well known in the relevant art, the location (place of business) of these readers is typically known as is the merchant who is using them. In the POS scenario during the payment verification process, the geographic locations of the user at the POS, or POS's, is known and the location of the user is based thereon. Another aspect of the invention is a mobile merchant. If a user location or activity is identified based upon interaction with a mobile merchant a related second participating party ad may be sent to the user and if a subsequent act by the user is associated with the ad and the second participating party will pay a bounty/benefit, or similar, to the mobile merchant.

Additional aspects of an embodiment of the invention can be illustrated by the system 300 of FIG. 3. The system 300 can implement a method for MEID (merchants, establishments and information distribution “points”) to use a POS, POI or SR device to trigger the serving of advertising or other information to customers/users. The method can also identify the user's wireless device or subscriber account in order to receive payment from said merchants upon the positive actions taken by the customer/user.

The platform 307 in FIG. 3 may be a LAN or it may be integrated with other networks. Regardless, information can be stored on a network' (telecommunications or Internet) integral to, or peripheral to, the system 300 or the platform 307.

Another aspect of the embodiment of the invention is depicted, in part, in FIG. 3 wherein is the platform 307 onto which information, advertisements, sales offers, and similar, or functional equivalents thereof (hitherto referred to as AISO's), can be placed by businesses, such as stores, retail stores, information centers, transportation centers, real estate locales, housing centers, sporting or performance venues (overall—merchants, establishments and information distributors—heretofore and hitherto referred to as “MEID's”). On the platform 307, a subscribing participating MEID's can place, or a non-subscribing but participating MEID can purchase, new or predetermined AISO's (see self-serve ad purchasing engine 305) and users can control when, where, whether and/or how they are contacted by MEID's. The AISO's are then able to be transferred to the user and in one aspect of the invention immediately to the user's mobile device via a network. The user has the option of receiving the AISO or receiving notification of an accessible AISO. AISO's may also be sent to locations on the network determined by the user set forth on the platform 307. It then may be the user's option as to if and when and where she accesses the AISO's. Once the AISO is communicated to the user another aspect of the invention, on the platform 307, or network, is knowledge of a user's actions by subsequent triggering of a POS, POI or SR and the determination of whether the subsequent triggering is related to the AISO communicated to the user. Another aspect of the invention is knowledge of the time, or precise time, of these POS, POI, and SR (or other) triggerings. Depending upon the circumstances and associated programming of the system 300 a “timely” subsequent triggering may result in a bounty—preferably a transfer of monies from the MEID to the first merchant.

Another aspect of the invention is the ability for MEID's to place time sensitive AISO's that can be proven to have been acted upon by users by subsequent triggering of POS, POI, SR's (or as in all references to readers any other means of establishing location and preferably time).

In a further aspect of the invention, on the platform 307, is the ability for the user to benefit from participation wherein the user may benefit from by activity associated with another participating party—whether it is perusing a web site, making a brink and motor purchase, or acting upon an AISO. The user may accumulate the benefits, offers, and/or information (heretofore referred to as ‘units’) collected during movements through locations and triggering of POS, POI or SR or other means for identifying a location of a user.

Another aspect of the invention is the ability for users to transfer units to other users (when allowed by the AISO that was positioned by the MEID or when allowed by the system 300 or the participating MEID or the MEID paying (which may merely be transferring) the benefit to the user.

In a further aspect of the invention, on the platform, is the ability for MEID's to receive a benefit, potentially funds, directly from other MEID's (that had placed AISO's to be triggered in the location of the before mentioned MEID) and that were proven to be acted upon by the user (e.g., by triggering a POS POI or SR or similar)—preferably at the location of a MEID, who is, or who is associated with the MEID (that had placed the AISO).

In another aspect of the invention, on the platform 307, or alternatively directly or indirectly on the network to which the platform 307 is connected (a possible architecture in this aspect and others), is the ability for MEID's to bid against other MEID's for positioning of AISO's that will be sent to users that trigger POS, POI or SR or similar at other MEID's.

A further aspect of the invention is the ability for users and MEID's to view all of the MEID's within any geographic area desired.

Another aspect of the invention is the ability for the platform to gain knowledge of the actions of users as POS, POI and SR or similar are triggered. Gained knowledge may be utilized by AI to benefit all the participating parties. MEID's by for example learning what AISO's and delivery formats (including timing, content, associated MEID's, and/or geography/location parameters) are most effective and profitable, and users by ascertaining activity, including purchases, patterns or ascertaining patterns, AISO's and/or MEID's that are to differential benefit to the user. In another words another aspect of the invention, on the platform, is the ability to gain cumulative knowledge of cumulative user activity within specific geographic locations or in association with certain MEID's or certain AISO's.

In general, the detailed description of the aspects and embodiments of the invention is not intended to be exhaustive or to limit the invention to the precise form disclosed above. While specific embodiments of, and examples for, the invention are described above for illustrative purposes, various equivalents modifications are possible within the scope of the invention, as those skilled in the relevant art will recognize. For example, while processes or blocks are presented in a given order, alternative embodiments may perform routines have steps, or employ systems having blocks, in different order, and some processes or blocks may be deleted, moved, added, subdivided, combined, and/or modified. Each of these processes or blocks may be implemented in a variety of different ways. Also, while processes or clocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other date storage media. Indeed, computer implemented instructions, data structures, screen displays, and other date under aspects of the invention may be distribute over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the art will recognize that portions of the invention reside on a server computer, while corresponding portions reside on a client computer such as a mobile or portable device, and thus, while certain hardware platforms are described herein, aspects of the invention are equally applicable to nodes on a network,

The teaching of the invention provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain aspects, portions, and embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

We claim:

1. A method of doing business comprising the steps of:
identifying a location of a user;
identifying a first entity based upon the location;
providing user with a data packet based upon the first entity;
determining whether the user committed an act based upon the data packet; and
benefiting the first entity.

2. The method as defined in claim 1 wherein identifying the location of the user is based upon a commercial act by the user.

3. The method as defined in claim 2 wherein the commercial act by the user is a POS purchase associated with the first entity.

4. The method as defined in claim 2 including identifying a second entity based upon the location wherein the data packet includes information related to the second entity.

5. The method as defined in claim 4 wherein the second entity transfers the benefit to the first entity.

6. The method as defined in claim 4 wherein the act committed by the user is of a commercial nature at the second entity.

7. The method as defined in claim 6 wherein the act committed by the user is POS purchase associated with the second entity.

8. The method as defined in claim 4 wherein the data packet information is an advertisement for the second entity.

9. An information-benefit distribution system comprising:
means for identifying a location of a user;
means for identifying a first entity based upon the location;
means for providing user with a data packet based upon the first entity;
means for determining whether the user committed an act based upon the data packet;
means for benefiting the first entity.

10. The system as defined in claim 9 wherein means for identifying the location of the user is based upon a commercial act by the user.

11. The system as defined in claim 10 wherein the commercial act by the user is a POS purchase associated with the first entity.

12. The system as defined in claim 10 including means for identifying a second entity based upon the location wherein the data packet includes information related to the second entity.

13. The system as defined in claim 12 wherein the second entity transfers the benefit to the first entity.

14. The system as defined in claim 12 wherein the act committed by the user is of a commercial nature at the second entity.

15. The system as defined in claim 14 wherein the act committed by the user is POS purchase associated with the second entity.

16. The system as defined in claim 12 wherein the data packet information is an advertisement for the second entity.

17. A method of doing business comprising the steps of:
identifying an activity of a user;
identifying a first entity based upon the activity;
identifying a second entity based upon the first entity;
providing the user with a data packet;
determining whether the user committed an act based upon the data packet; and
means for the second entity to benefit the first entity.

18. The method as defined in claim 17 wherein the means for identifying the second entity is based upon the activity.

19. A method for a first participating merchant to use a POS, POI or SR device to identify a user's wireless device, serve a second participating merchant advertising or information to the user's wireless devices or subscriber account in order to promote the second merchant and wherein the first merchant receives payment from the second merchants, the method comprising:
automatically generating at least one advertisement and delivering it to the user's mobile device;
writing tracking information to a database if the wireless device is recorded within a participating merchant's location; and
writing merchant credit to the database when a successful transaction occurs.

20. The method of claim 19 wherein a location is associated with the first merchant.

21. The method of claim 20 further comprising the step of writing purchase information to a database responsive to a user associated with the mobile device making a purchase at the first merchant's place of business.

22. The method of claim 21 further comprising the step of writing purchase information to the database responsive to a user associated with the mobile device making a purchase at the second merchant's place of business with which the advertisement is associated.

23. The method of claim 19 wherein the predetermined amount of time of the offer varies by advertising merchant.

24. The method of claim 19 wherein the timing of the advertising delivery is set by the user.

25. The method of claim 23 wherein the predetermined amount of time is stored in the data base.

26. The method of claim 19 further comprising the step of writing failure information to the database when the user' mobile device fails to complete a transaction based on a delivered advertisement.

27. The method of claim 19 wherein success information comprises time elapsed between a time that the advertisement data was sent to the user's mobile device and a time that the mobile device was located at the second merchant.

28. The method of claim 19 wherein success information comprises a completed transaction with the second merchant from the time when the advertisement data was originally sent to the user's mobile device.

29. The method of claim 19 wherein success information comprises an elapsed time between a time that the advertisement data was sent to the user's mobile device and a time that the user's mobile device made a purchase associated with the second merchant.
